(19) United States
(12) Patent Application Publication
(10) Pub. No.: US 2025/0067018 A1
(43) Pub. Date: Feb. 27, 2025

(54) CIVIL ENGINEERING DEVICE AND METHOD FOR OPERATING A CIVIL ENGINEERING DEVICE

(71) Applicant: BAUER Maschinen GmbH, Schrobenhausen (DE)

(72) Inventors: Andreas HUGL, Burgheim (DE); David PFEIFFER, Schrobenhausen (DE); Andreas SCHUELL, Gerolsbach (DE)

(73) Assignee: BAUER Maschinen GmbH, Schrobenhausen (DE)

(21) Appl. No.: 18/814,082

(22) Filed: Aug. 23, 2024

(30) Foreign Application Priority Data
Aug. 24, 2023 (EP) 23 193 264.1

(51) Int. Cl. E02F 3/47; E02F 9/20

(52) U.S. Cl. CPC E02F 3/475; E02F 9/2016; E02F 9/2095

(57) ABSTRACT

The invention relates to a civil engineering device, in particular cable grab, with a support apparatus, a processing unit, which is configured to carry out a civil engineering step and is held by way of at least one cable on the support apparatus, at least one cable winch for operating the cable, wherein the cable winch has a winch drum and an associated winch motor for driving the winch drum rotationally, at least one free fall brake, which is arranged on the at least one cable winch, wherein in a closed state of the free fall brake, the winch drum is coupled to the associated winch motor, in a partially open state of the free fall brake, a relative movement is possible between winch drum and winch motor, wherein a torque that is dependent on the degree of opening of the free fall brake is transmitted in the free fall brake, and in an open state the winch drum is decoupled from the associated winch motor and is substantially freely rotatable with respect to this. It is provided according to the invention that an electronic control device is arranged for the controlled opening, partial opening and closing of the free fall brake by means of at least one control element, that a lowering speed and/or a lowering path can be preset as target values in the control device, that at least one detection device is arranged, which is configured to detect a lowering speed of the processing unit and/or a lowering path as actual values, and that the control device is connected to the at least one detection device and is configured to control opening, partial opening and closing of the free fall brake depending on the actual values detected so that the actual values approach the preset target values.

The invention relates to a civil engineering device, in particular cable grab, with a support apparatus, a processing unit, which is configured to execute a civil engineering step and is held on the support apparatus by way of at least one cable, at least one cable winch for operating the cable, wherein the cable winch has a winch drum and an associated winch motor for rotationally driving the winch drum, at least one free fall brake, which is arranged on the at least one cable winch, wherein in a closed state of the free fall brake, the winch drum is coupled to the associated winch motor, in a partially open state of the free fall brake a relative movement is possible between winch drum and winch motor, wherein a torque is transferred in the free fall brake, which torque is dependent on the degree of opening of the free fall brake, and in an open state, the winch drum is decoupled from the associated winch motor and is substantially freely rotatable with respect to this, according to the preamble of claim 1.

In the case of certain civil engineering devices, in particular so-called cable grabs, it is frequently necessary to repeatedly lower and raise again a processing unit for carrying out a civil engineering step by way of a cable using a cable winch. In the case of a cable grab or a drilling bucket, for instance, as a processing unit, it is necessary following a civil engineering step to pull the cable grab or drilling bucket filled with removed ground material out of the hole created in the ground again and to move it to an emptying point for emptying. The processing unit is then to be moved back into the drill hole again for a renewed processing step.

To conduct the process efficiently, the aim in this case is to carry out the raising and in particular the lowering of the processing unit as quickly as possible.

EP 4 134 489 A1, for example, shows a civil engineering device with a cable grab. In the case of cable grabs, for lowering it is known to lower the grab either by frictional actuation and driving of the cable winch in a lowering direction or due to the dead weight of the cable grab by partial or complete opening of a so-called free fall brake. In all cases this is performed manually by the machine operator.

With frictional lowering by means of rotary drive of the winch in the lowering direction, control of the lowering speed can be achieved in principle. Due to the maximum possible speed of the winch motor, however, only a limited lowering speed can be attained.

When lowering the cable grab with completely or partially decoupled winch drive, a much greater lowering speed can be attained due to complete or partial opening of the free fall brake, on the other hand. However, there is no control of the movement by the machine controller. When lowering a cable grab in free fall, the machine operator must stand perpetually on the control pedal of a free fall brake in order to control the lowering speed through the pedal position. In this case it is not easy to find the correct pedal position. This depends heavily on the experience of the machine operator. Furthermore, long-term operation of the control or brake pedals for controlling lowering is ergonomically strenuous.

In particular, no control by the machine controller exists with regard to a maximum lowering speed and also the lowering path. This is to be controlled by the machine operator according to his or her experience. In the past this repeatedly resulted in damage at the free fall brake, as this can overheat, above all in the event of longer lowering paths, higher lowering speeds and heavy cable grabs.

The problem consists in that the winch motor is stationary when lowering in free fall. This means that the plates in the free fall brake that are connected to the winch motor stand still while the plates connected to the winch drum rotate according to the lowering speed of the cable grab. For lowering with a partially open free fall brake, this means that the plates pairs in the free fall brake rub against each other. This results in wear of the plates on the one hand and heating of the free fall brake on the other hand, which can lead to overheating of the free fall brake.

The object of the invention resides in to specify a civil engineering device and a method for operation with which a processing unit on a civil engineering device can be lowered particularly efficiently.

The object is achieved according to the invention on the one hand by a civil engineering device with the features of claim 1 and on the other hand by a method with the features of claim 11. Preferred embodiments of the invention are indicated in the respectively dependent claims.

The civil engineering device according to the invention is characterized in that an electronic control device is arranged for the controlled opening, partial opening and closing of the free fall brake by means of at least one control element, that a lowering speed and/or a lowering path can be preset as target values in the control device, that at least one detection device is arranged, which is configured to detect a lowering speed of the processing unit and/or a lowering path as actual values, and that the control device is connected to the at least one detection device and is configured to control opening, partial opening and closing of the free fall brake depending on the actual values detected, so that the actual values approximate to the preset target values, in order to correspond to these.

A basic idea of the invention lies in opening, partially opening and closing the free fall brake in an inventive manner controlled by an electronic control device. To this end at least one controllable control element for opening, partially opening and closing is arranged on the free fall brake.

According to another aspect of the invention, target values are stored in the control device, which values relate at least to a lowering speed or a lowering path. The actual values corresponding to the target values, thus at least the actual lowering speed or the actual lowering path, can be detected by means of at least one detection device. The lowering speed can be detected directly or indirectly via a corresponding value, for instance the rotational speed of the cable winch. Correspondingly a lowering path of the processing unit can also be detected directly or indirectly, for instance via the number of revolutions or the rotary position of the free fall winch.

According to another aspect of the invention, the control device is configured such that depending on the actual values detected, this controls opening, partial opening and closing of the free fall brake, so that the actual values approach the preset target values, in order ideally to correspond to these. Automatic control of the free fall brake depending on actual data to the processing unit is achieved, so to speak.

Using the civil engineering device according to the invention, largely automated free fall operation can thus be implemented for lowering a processing unit. Here the advantages of energy-efficient and particularly rapid lowering in free fall mode can be attained on the one hand. Due to automation of the control of the free fall brake for opening, partial opening and closing, the burden on the machine operator is significantly reduced on the other hand, as long-term operation of control or brake pedals is no longer necessary. The process can be controlled by machine overall.

A preferred embodiment of the invention consists in that the at least one winch motor is controlled by the control device and that the control device is configured to operate the associated winch motor when opening or partially opening the free fall brake of the cable winch, in order to drive the winch drum rotationally in the direction of lowering of the cable. According to this continuing formation, the control device also controls the winch motor. The control device is configured in particular such that when opening or partially opening the free fall brake of the cable winch, the associated winch motor is also operated in the direction of lowering the cable. This seemingly paradoxical operation of the winch motor for lowering simultaneously with opening or partial opening of the free fall brake and thus an at least partial decoupling of the winch drum from the winch motor has the advantage, however, that wear on the plates of the free fall brake and the development of heat in the free fall brake are reduced due to a reduction in the speed differences between the plates pairs in the free fall brake.

Slippage can arise, furthermore, between the plates connected to the winch motor and the plates connected to the winch drum. The lowering speed can change due to this slippage. Moreover, the free fall brake in particular can be opened slowly while the winch motor is already running in the lowering direction, which likewise can lead to gentler lowering in this start phase and reducing wear on the plates.

According to a development of the invention, it is advantageous that the control device has at least one input device for entering the lowering speed and/or a lowering path as target values and/or control commands. The input device can be configured in basically any manner, in particular as a keyboard, as a touchscreen or through suitable rotary switches. The machine operator is hereby enabled to specify and set the respectively desired values in each construction measure.

According to another implementation variant of the invention, it is preferred that the control device is configured with an automatic control program, in which upon entry of a start and/or stop command, free fall operation of the at least one free fall winch is started or respectively stopped by gradual opening or partial opening or respectively closing of the free fall brake over a preset time span. By gradual opening or partial opening and closing of the free fall brake over a preset time span when starting or respectively stopping, particularly gentle operation can be achieved, which has a positive influence on the service life of individual components and the civil engineering device as a whole.

A particularly preferred embodiment also consists in that the input device of the control device comprises a joystick, which is tiltable, wherein a lowering speed is controllable by the operator by a tilt angle of the joystick. Thus, particularly simple and for the operator not very strenuous control of the lowering speed can be achieved by means of a joystick by single-handed operation. Speed control by means of a joystick by tilting the joystick also facilitates particularly intuitive speed adjustment.

Another advantageous embodiment of the invention lies in that the input device of the control device has a control button, in particular on a joystick, for starting and stopping an automatic control program. In this way the winch can be initially controlled manually by joystick, in particular in respect of the lowering speed, wherein a machine operator can transition to automatic operation by simple actuation of a control button. Further control of the lowering speed and if applicable the lowering path can take place in this way via the automatic control program. The control button is preferably arranged directly on the joystick, so that lowering can take place in an ergonomically rational manner in single-handed operation.

The free fall brake can be configured in principle in any suitable manner. It is particularly advantageous according to one implementation variant of the invention that the at least one free fall brake is configured like a multi-plate clutch with several friction discs, also termed plates, which can be pressed against one another for braking. The free fall brake is constructed in the manner of a multi-plate clutch so that a contact and friction surface increases according to the number of plates arranged. This permits a particularly high force transmission.

By axial pressing on one another, the plates are connected to one another by force-fit or frictionally engaged, so that a force transmission is enabled between them. In particular, the winch drum, which is connected to the plates of a first side, can be connected thus in a torque-proof manner to the winch motor or a holding element, which are connected to the opposing plates of a second side. An accordingly gentle braking effect can be effected by suitably slow axial adjustment of the plates relative to one another.

According to a development of the invention, it is provided that the civil engineering device has a cable grab with grab shovels, in particular as a diaphragm wall grab with an approximately rectangular guide frame or as a drill gripper with an approximately cylindrical guide frame, and that arranged on the grab shovels are removal teeth, which are configured to remove soil.

The cable grab can be connected via a corresponding cable suspension on a mast or a boom arm to the support apparatus on which the winch is arranged. The support apparatus can preferably be movable and in particular comprise a crawler chassis.

According to a continuing formation of the invention, it is advantageous that the cable grab has a first cable for raising and lowering the cable grab and a second cable for opening and closing grab shovels and that the two cables are each operable by a cable winch. The cable winches are preferably arranged on the support apparatus. This permits a particularly compact construction of the civil engineering device.

The inventive method for operating a civil engineering device is characterized in that an inventive civil engineering device is used, that the at least one free fall brake is opened and closed controlled by means of an electronic control device by means of at least one control element, that a lowering speed and/or a lowering path are preset as target values in the control device, that a lowering speed and/or a lowering path of the processing unit are detected as an actual value by means of a detection device and that depending on the actual values detected, opening, partial opening and closing of the free fall brake is controlled by means of the control device, so that the actual values approach the preset target values.

The inventive method can be carried out, in particular with the previously described inventive civil engineering device. In doing so, the previously described advantages can be achieved. In particular, the previously described civil engineering device can also be operated according to the inventive method.

The civil engineering device can be configured in principle to execute any civil engineering method. It is particularly preferable according to a continuing formation of the invention that soil is removed by means of the civil engineering device. The soil removal can take place in particular in a discontinuous process.

One implementation variant of the invention consists in that a civil engineering device with a cable grab is used, wherein by means of the cable grab a slot with a rectangular slot cross section or a hole with a circular hole cross section is created. By opening and closing the grab shovels, ground material can be taken up in the cable grab when creating a hole in the ground. The filled cable grab can be pulled out of the hole and moved to an emptying point. Following emptying, the cable grab can be returned to the processing point again and lowered into the hole by corresponding operation of a cable winch. In particular, lowering can take place according to the inventive method.

The invention is further explained below on the basis of preferred exemplary embodiments, which are depicted schematically in the drawings. In the drawings show

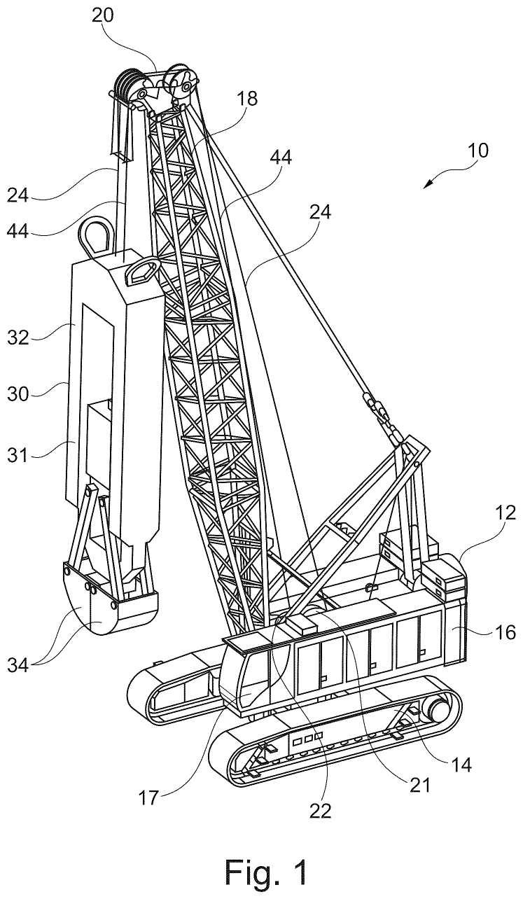

FIG. 1 a view in perspective of an inventive civil engineering device with a cable grab;

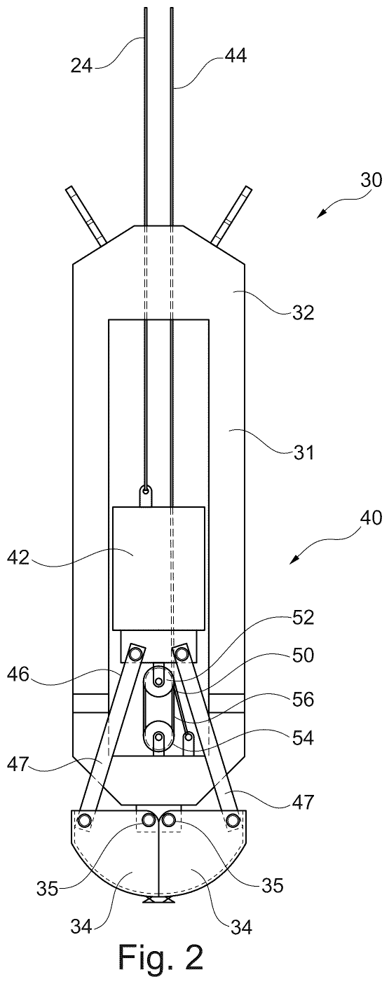

FIG. 2 a front view of the cable grab of the civil engineering device of FIG. 1 with closed grab shovels;

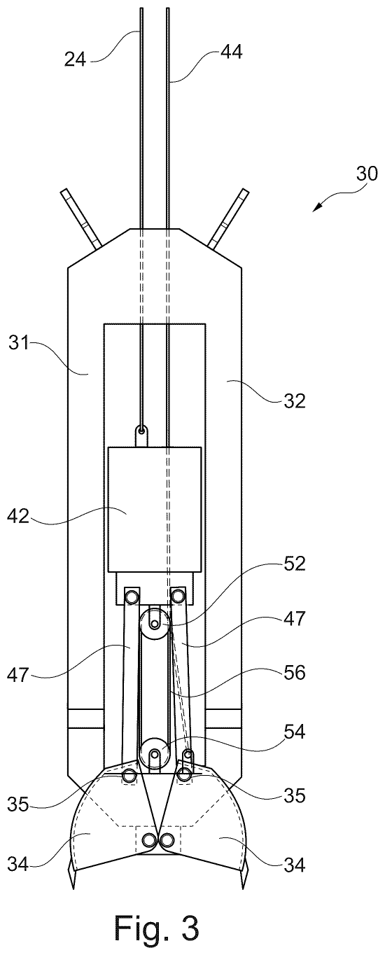

FIG. 3 a front view of the cable grab according to FIG. 2 with open grab shovels; and

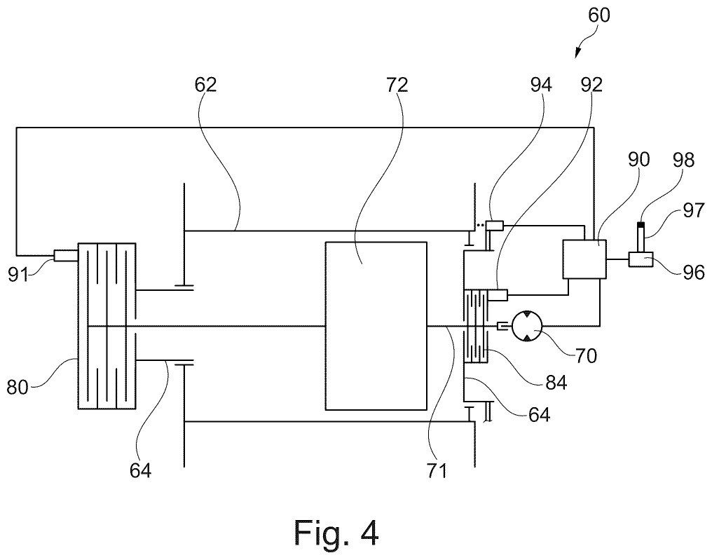

FIG. 4 a schematic cross-sectional representation for a winch arrangement with free fall brake for an inventive civil engineering device.

An inventive civil engineering device 10 according to FIG. 1 can have a mobile support apparatus 12 with a crawler chassis as undercarriage 14. On the undercarriage 14, an upper carriage 16 with an operating cabin 17 can be supported rotatably about a vertical axis of rotation. Located preferably inside the operating cabin 17 is a control device including an input device for a machine operator.

A boom arm 18 can be articulated pivotably about a horizontal axis on the upper carriage 16. A retaining cable 24 can be guided at a head 20 of the boom arm 18 with deflection pulleys, at the end of which cable a processing unit 30 configured as a cable grab 31 with a grab frame 32 and lower grab shovels 34 can be attached. The retaining cable 24 can be operated via a first cable winch 21 on the support apparatus 12 for raising and lowering the cable grab 30. Furthermore, a second cable winch 22 can be located on the support apparatus 12 for an operating cable 44, which can be guided via the head 20 likewise to the cable grab 30 for operating the grab shovels 34 at the lower end of the grab frame 32.

The operating mode of the inventive civil engineering device 10 is explained in greater detail below in connection with FIGS. 2 and 3.

In a central area of the grab frame 32, an operating carriage 42 of an operating device 40 for operating the grab shovels 34 can be supported displaceably in a vertical longitudinal direction. The end of the retaining cable 24 can be affixed at the upper end of the operating carriage 42, so that the cable grab 31 is held via the operating carriage 42.

A link mechanism 46 with link rods 47 can be arranged at a lower end of the operating carriage 42. The link rods 47 are preferably articulately connected on the one hand to the operating carriage 42 and on the other hand to one of the grab shovels 34. The grab shovels 34 can themselves be supported by way of pivot bearings 35 pivotably at the lower end of the grab frame 32. The grab shovels 34 can be opened and closed by a relative displacement of the operating carriage 42 in relation to the grab frame 32. The link rods 47 can be pulled upwards by a relative displacement of the operating carriage 42 upwards, wherein the grab shovels 34 are pivoted about their pivot axes 35 into their opening position, which is shown clearly in FIG. 3.

A block and tackle arrangement 50 for the operating cable 44 can be provided below the operating carriage 42. The block and tackle arrangement 50 can have an upper pulley 52, which is supported rotatably on the operating carriage 42, and a lower pulley 54, which is supported rotatably on a lower region of the grab frame 32. The pulleys 52, 54 can be winded multiple times around by the operating cable 44 supplied from above with the formation of enlacements 56 or lengths, wherein the lower end of the operating cable 44 is connected fixedly to the grab frame 32. The operating carriage 42 can thus be connected or coupled to the grab frame 32 adjustably by way of the operating cable 44.

Starting from the opening position according to FIG. 3, the operating carriage 42 can be pulled downwards by the block and tackle arrangement 50 relative to the grab frame 32 by pulling the operating cable 44 upwards by the second cable winch 22. The link rods 47 thereby press the grab shovels 34 downwards with an increased closing force, wherein the grab shovels 34 are pivoted about their pivot bearings 35 into the closing position according to FIG. 2.

During use in a slot in the ground, soil material can be grasped in the process with an increased closing force compared with the tensile force on the operating cable 44 and can be enclosed between the grab shovels 34.

After pulling the cable grab 31 out of a slot in the ground and after moving it to an emptying position, the tensile force on the operating cable 44 can be reduced. In this way the grab frame 32 can move downwards on account of its weight force relative to the operating carriage 42, so that the grab shovels 34 are pivoted via the link rods 47 back into their opening position, as depicted in FIG. 3.

This described arrangement is only by way of example. Other block and tackle arrangements with different cable linkages and a different link mechanism, which facilitate a comparable grab shovel operation, can also be selected in principle.

When operating the cable grab 31, coordination of the forces and movements between the retaining cable 24 and the operating cable 44 is necessary in order to control the torques in the individual cables and thus the torques of the attached cable grab 31 about its longitudinal axis, in particular on account of a so-called lay direction in the case of wound cables, in such a way that a desired rotation of the cable grab 31 only then occurs if this is required for the construction sequence.

Forces in the retaining cable 24 and the operating cable 44 can be detected by way of appropriate detection devices, which can, for example, be arranged on the cable winches 21, 22 or on the deflection pulleys at the head 20 of the boom arm 18. Via a control device, which is preferably arranged in the operating cabin 17 on the support apparatus 12, the winches 21, 22 can be controlled depending on the cable forces detected in such a way that either stabilization of the pivot-orientation of the cable grab 31 about its longitudinal axis or a targeted twisting desired by the machine operator can be achieved. Only appropriate inputs for a optionally desired compensation mode for position stabilization or inputs for a desired rotary position of the cable grab 31 are necessary on the part of the machine operator. Based on this, the control device can activate the cable winches 21, 22 accordingly to effect the desired pivot-orientation of the cable grab 31. Control of a simply constructed cable grab 31 is hereby significantly simplified and made easier for a machine operator.

Following emptying of the grab shovels 34, the cable grab 31 can be lowered into the hole in the ground again. This can take place in a controlled free fall mode, which is explained below in connection with the winch arrangement according to FIG. 4.

The exemplary winch arrangement according to FIG. 4 has a cable winch 60 with a winch drum 62, which can be mounted rotatably on a winch frame 64. The winch drum 62 is driven rotationally by a schematically indicated winch motor 70, which can be implemented as a hydraulic motor, via a drive shaft 71 and a schematically indicated winch gear 72, which can be a single- or multi-stage planetary gear. The cable winch 60 can form at least one or both winches 21, 22 of the civil engineering device 10 previously described.

Arranged according to the invention between the winch motor 70 and the winch drum 62 is a free fall brake 80, which is constructed in the manner of a multi-plate clutch or multi-plate brake. By operating the free fall brake 80, a torque-proof coupling can be effected between the winch motor 70 and the winch drum 62 on the one hand, in particular with the drive shaft 71 of the winch drum 62, and a decoupled or partially decoupled state can be effected on the other hand. In the decoupled state, the winch drum 62 of the cable winch 60 can rotate freely without a torque-proof connection existing to the winch motor 70. By gradual adjustment of the plates of the free fall brake 80, intermediate states between the coupled and decoupled state can also be set in which a certain slippage can occur between the winch motor 70 and the winch drum 62, which in turn effects friction between the plate pairs of the free fall brake 80.

Holding and locking of the winch drum with respect to the winch frame 64 can take place by means of a holding brake 84. A control device 90 is arranged according to the invention for control, which device can be formed by a computer or other electronic control unit, for instance. Activation of the winch motor 70, in particular in respect of speed, torque, rotary position etc., can take place via the control device 90. Furthermore, the control device 90 can be configured with a first actuator 91 for opening, partial opening and closing of the free fall brake 84. The holding brake 84 can be operated by the control unit 90 via a second actuator 92.

A machine operator can enter target values into the control device 90 for a lowering speed or respectively a rotation of the winch drum 62 and/or a lowering path of the processing unit 30. Furthermore, the machine operator can activate the winch motor 70 and the free fall brake 84 via the control device 90. In particular, a joystick 97 is provided as an input device 96 for the control device 90, with which joystick the machine operator can control a lowering speed of the processing unit 30 attached to the cable winch 60 by tilting the control lever. By way of a control button 98 on the joystick 97, a machine operator can activate or deactivate an automatic program.

A rotary position and/or speed of the winch drum 62 can be detected via a detection device 94 and forwarded to the control device 90 as an actual value for a lowering speed and/or a lowering path of the attached processing unit 30. The corresponding data can be displayed on a monitor, not depicted in FIG. 4, to a machine operator.

Upon activation of the automatic control program, automatic operation of the free fall brake 84 by the control device 90 can take place such that the actual values detected by the detection device 94 correspond to the preset target values in respect of the lowering speed or respectively of the lowering path or at least approach towards these.

In the case of a processing unit 30 such as a cable grab 31 with two cables 24, 44, both winches 21, 22 can be activated at the same time to bring about lowering of the processing unit 30 or respectively the cable grab 31 without opening or respectively closing the grab shovels 34.

1. A civil engineering device, in particular with a cable grab, comprising
a support apparatus,
a processing unit, which is configured to carry out a civil engineering step and is held by way of at least one cable on the support apparatus,
at least one cable winch for operating the cable, wherein the cable winch comprises a winch drum and an associated winch motor for driving the winch drum rotationally,
a free fall brake, which is arranged on the one cable winch, wherein in a closed state of the free fall brake, the winch drum is coupled to the associated winch motor, in a partially open state of the free fall brake, a relative movement is possible between winch drum and winch motor, wherein a torque that is dependent on the degree of opening of the free fall brake is transmitted in the free fall brake, and in an open state the winch drum is decoupled from the associated winch motor and is substantially freely rotatable with respect to this,
wherein
an electronic control device is arranged for the controlled opening and closing of the free fall brake by means of at least one actuator,
a lowering speed and/or a lowering path can be preset as target values in the control device,
at least one detection device is arranged, which is configured to detect a lowering speed of the processing unit and/or a lowering path as actual values, and
the control device is connected to the at least one detection device and is configured to control opening, partial opening and closing of the free fall brake depending on the actual value or actual values detected so that the actual values approach the preset target values.

2. The civil engineering device according to claim 1,
wherein
the at least one winch motor is controlled by the control device and
the control device is configured to operate the associated winch motor in the direction of lowering upon opening or particularly partial opening of the free fall brake of the cable winch.

3. The civil engineering device according to claim 1,
wherein
the control device has at least one input device for the entry of the lowering speed and/or the lowering path as target values and/or of control commands.

4. The civil engineering device according to claim 1,
wherein
the control device is configured with an automatic control program, in which upon entry of a start and/or stop command, free fall operation is started or respectively stopped by gradual opening/partial opening or respectively closing of the free fall brake over a specified time span.

5. The civil engineering device according to claim 3,
wherein
the input device of the control device comprises a joystick, which is tiltable, wherein a lowering speed is controllable by an operator by a tilting angle of the joystick.

6. The civil engineering device according to claim 3,
wherein
the input device of the control device has a control button, in particular on a joystick, for starting and stopping an automatic control program.

7. The civil engineering device according to claim 1,
wherein
the free fall brake is configured in the manner of a multi-plate clutch with a number of friction plates, which can be pressed against one another for braking.

8. The civil engineering device according to claim 1,
wherein
this has a cable grab with grab shovels, in particular as a diaphragm wall grab with an approximately rectangular guide frame or as a drill grab with an approximately cylindrical guide frame and
arranged on the grab shovels are removal teeth, which are configured to remove soil.

9. The civil engineering device according to claim 8,
wherein the cable grab has a first cable for raising and lowering the cable grab and a second cable for opening and closing grab shovels and
the two cables are each operable by a cable winch.

10. The civil engineering device according to claim 1,
wherein
a number of cables are each arranged with a cable winch, which can be actuated in parallel or synchronously with one another.

11. A method for operating a civil engineering device,
wherein
a civil engineering device according to claim 1 is used,
the at least one free fall brake is opened and closed controlled by means of an electronic control device by means of at least one control element,
a lowering speed and/or a lowering path can be preset as target values in the control device,
a lowering speed and/or a lowering path of the processing unit are detected as actual values by means of at least one detection device and
depending on the actual values detected, opening and closing of the free fall brake is controlled by means of the control device so that the actual values approach the preset target values.

12. The method according to claim 11,
wherein
soil is removed by means of the civil engineering device.

13. The method according to claim 11,
wherein
a civil engineering device with a cable grab is used, wherein by means of the cable grab a slot with a rectangular slot cross section or a hole with a circular hole cross section is created.
